(19) United States
(12) Patent Application Publication
(10) Pub. No.: US 2006/0131358 A1
(43) Pub. Date: Jun. 22, 2006

(54) Stapler

(76) Inventor: Ching-Tsung Tsai, Chang Hua (TW)

Correspondence Address: TROXELL LAW OFFICE PLLC;SUITE 1404, 5205 LEESBURG PIKE, FALLS CHURCH, VA, 22041, US

(21) Appl. No.: 11/014,850

(22) Filed: Dec. 20, 2004

(51) Int. Cl. B25C 5/02

(52) U.S. Cl. 227/134; 227/156

(57) ABSTRACT

A stapler includes a lower casing base having its topside formed with an accommodating space in the interior for placing small-sized stationery therein. A casing cover is movably assembled on the accommodating space. The casing cover has its opposite ends respectively formed with an insert member and an elastic press retainer to be respectively engaged with the front and the rear vertical wall of the accommodating space. The casing cover can be easily and firmly assembled on the accommodating space, impossible to loosen and fall off.

### BACKGROUND OF THE INVENTION

1. Field of the Invention

This invention relates to a stapler, particularly to one provided with an accommodating space in a lower casing base for receiving small-sized articles therein and a casing cover able to be opened or covered easily and impossible to loosen and fall off after it is covered on the accommodating space.

2. Description of the Prior Art

A conventional stapler usually has its lower casing base provided with an accommodating space for receiving therein paper clips, staples and the like.

However, to assemble the casing cover of the lower casing base on the accommodating space, a rectangular plate is used to be inserted in a rectangular insert groove and fixed in position by pressing. Thus, after the casing cover is used for a period of time, the gap may become larger and larger and the casing cover is impossible to be firmly covered on the lower casing base and likely to fall off. In addition, to form an accommodating space in the lower casing base for receiving small-sized articles therein, it is necessary to increase the thickness of the lower casing base, thus enlarging the volume of the stapler.

### SUMMARY OF THE INVENTION

The objective of this invention is to offer a stapler including an upper casing base, a lower casing base and a staple box pivotally combined together. The upper and the lower casing base are made of plastic. The lower casing base has its topside bored with an accommodating space having its front vertical wall bored with an insert groove in the upper inner surface and its rear vertical wall formed with a recess in the upper inner surface. The recess has its upper edge formed with a blocking surface having functions of blocking and positioning. A casing cover to be covered on the accommodating space has its front end formed with an insert member to be inserted in the insert groove in the front vertical wall of the accommodating space and its rear end formed with an elastic press retainer having a basic portion extending downward from the topside. The basic portion of the elastic press retainer has its lower end bent upward to form an elastic press portion having a holding block extending outward at a location corresponding to the blocking surface of the recess in the rear vertical wall of the accommodating space. Thus, the casing cover can be firmly assembled on the accommodating space by mutual engagement of the holding block of the elastic press retainer and the blocking surface of the rear vertical surface of the accommodating space.

### BRIEF DESCRIPTION OF DRAWINGS

This invention will be better understood by referring to the accompanying drawings, wherein:

FIG. 1 is an exploded perspective view of a stapler in the present invention:

FIG. 2 is a perspective view of the stapler in the present invention:

FIG. 3 is a cross-sectional view of the stapler in the present invention:

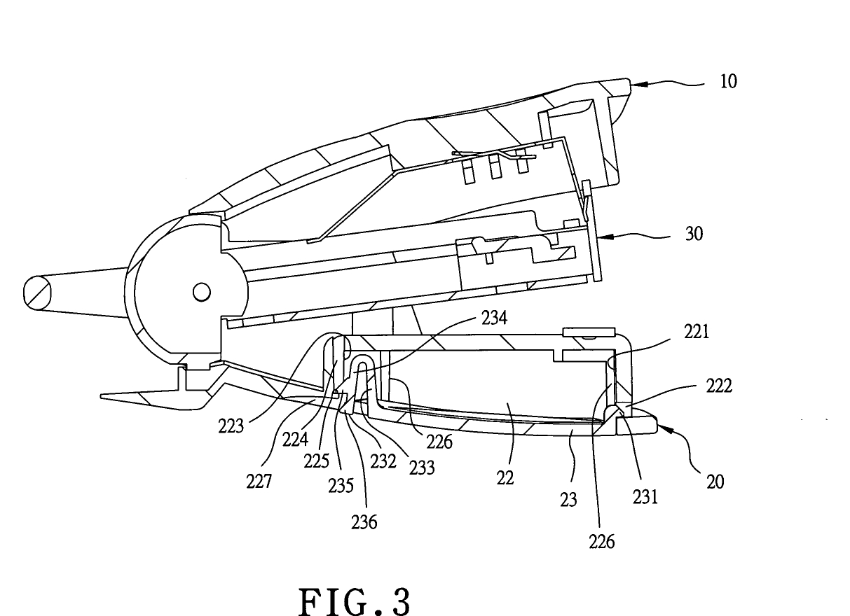

FIG. 4 is a cross-sectional view of the casing cover of the stapler in the present invention:

FIG. 5 is a cross-sectional view of the casing cover pushed inward to be covered on the lower casing base of the stapler in the present invention: and

FIG. 6 is a cross-sectional view of the casing cover pulled open in the present invention.

### DETAILED DESCRIPTION OF THE PREFERRED EMBODIMENT

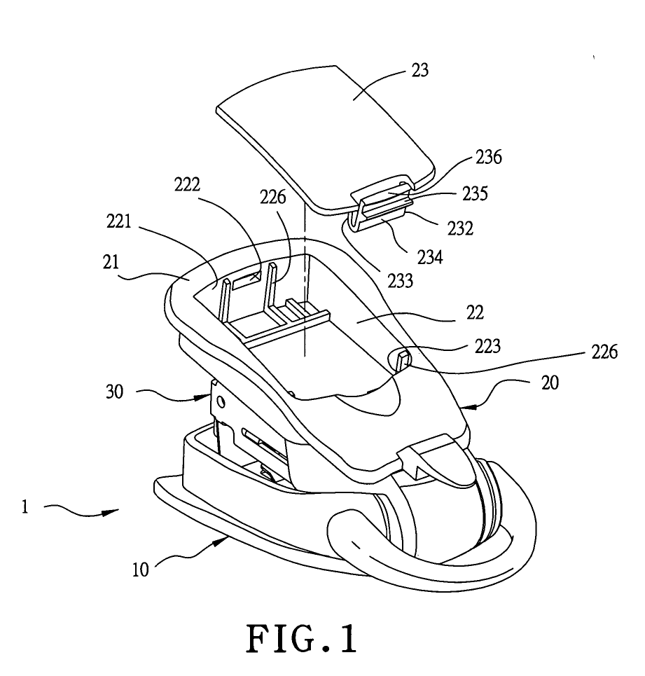

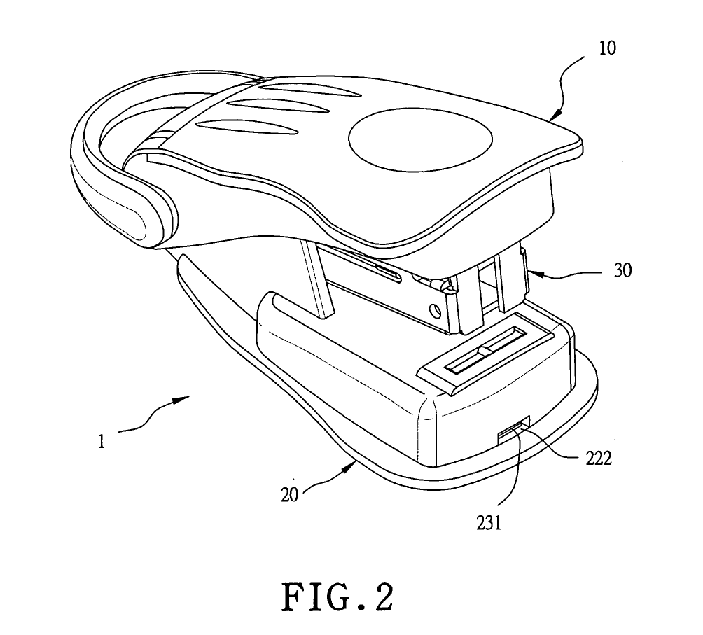

A preferred embodiment of a stapler 1 in the present invention, as shown in FIGS. 1 and 2, includes an upper casing base 10, a lower casing base 20 and a staple box 30 pivotally combined together. The staple box 30 and the upper casing base 10 are moved together to be pressed downward on the lower casing base 20 to release staplers for carrying out stapling work.

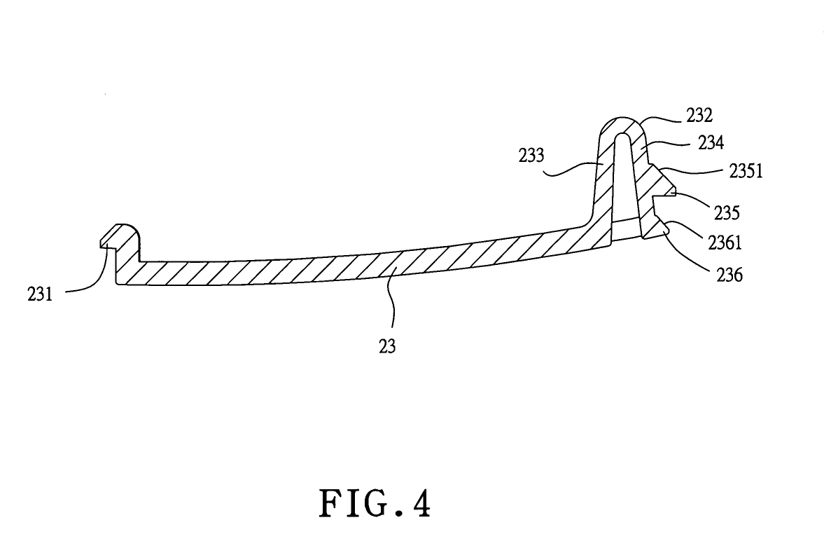

The upper and the lower casing base 10, 20 are made of plastic. The lower casing base 20 has its topside 21 formed with an accommodating space 22 having its front vertical wall 221 bored with an insert groove 222 in the upper inner surface and its rear vertical wall 223 bored with a recess 224 in the upper inner surface. The recess 224 has its upper edge formed with a blocking surface 225 having functions of blocking and positioning. The front and the rear vertical wall 221 and 223 of the accommodating space 22 are respectively provided with ribs 226 respectively positioned at the opposite sides of the insert groove 222 and the recess 224 for reinforcing the structure of the lower casing base. In addition, a casing cover 23 to be covered on the accommodating space 22, as shown in FIG. 4, has its front end formed with an insert member 231 to be inserted and positioned in the insert groove 222 in the front vertical surface 221 of the accommodating space 22 and its rear end formed with an elastic press retainer 232 corresponding to the recess 224 in the rear vertical surface 223 of the accommodating space 22. The elastic press retainer 232 is formed with a basic portion 233 extending downward from the topside of the casing cover 23. The basic portion 233 has its lower end bent upward to form an elastic press portion 234 having a holding block 235 extending transversely at a location corresponding to the blocking surface 225 at the upper edge of the recess 224 in the rear vertical surface 223 of the accommodating space 22. The holding block 235 has its lower side formed with a guiding slope 2351. Further, the elastic press retainer 232 has its top edge formed with a pull member 236 extending transversely and having its lower side formed with a guiding slope 2361 for facilitating operation of the elastic press portion 234. In addition, the lower casing base 20 has its topside 21 formed with an arc-shaped recessed surface 227 at a location corresponding to the pull member 236 to form a preset space for facilitating operation of the pull member 236.

The stapler 1 of this invention has its lower casing base 20 formed with the accommodating space 22 for placing therein small-sized stationery, such as staples, paper clips and the like. Thus, the stapler 1 and some spare small-sized stationery are convenient to be carried out for use. In addition, a plurality of rows of staples can be received in the accommodating space 22 of the stapler 1 and carried about to increase additional value of products.

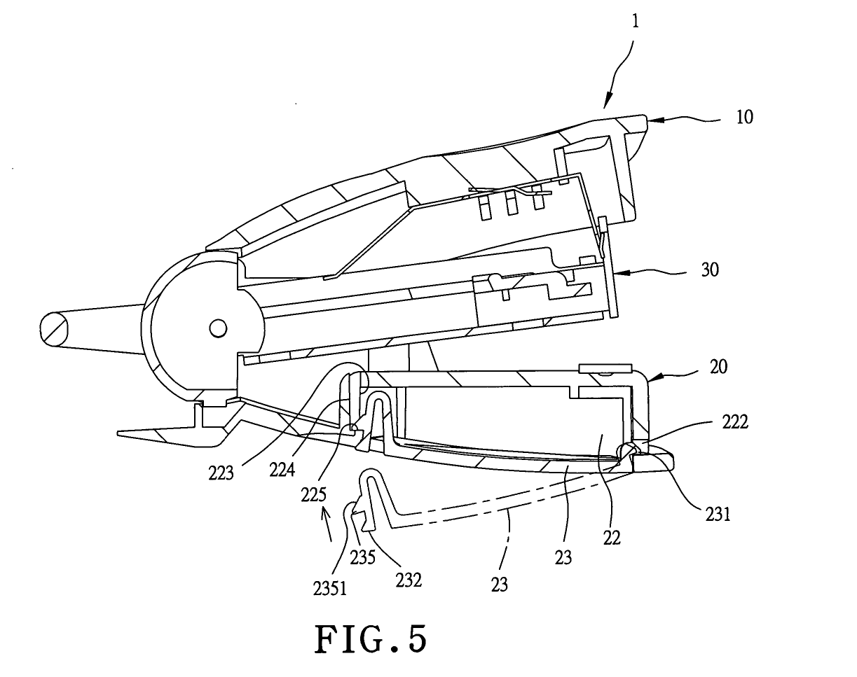

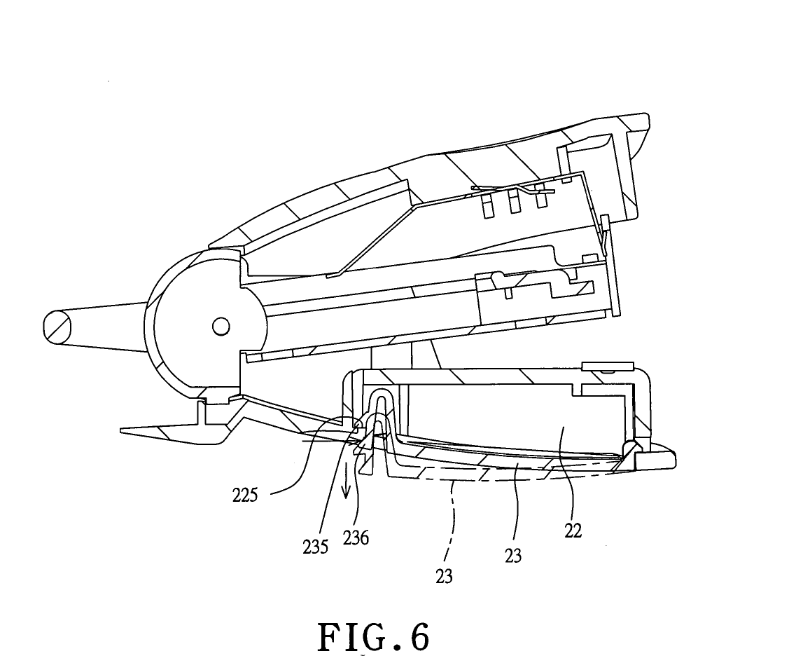

To assemble the casing cover 23 on the accommodating space 22, as shown in FIGS. 5 and 6, firstly, the insert plate 231 of the casing cover 23 is inserted in the insert groove 222 of the lower casing base 20 and then the elastic press retainer 232 of the casing cover 23 is pressed to move toward the accommodating space 22. At this time, the guiding slope 2351 of the holding block 235 is moved upward along the rear vertical surface 223 of the accommodating space 22 and then guided in the recess 224 to let the holding block 235 stuck on the blocking surface 225 and the casing cover 23 firmly assembled on the lower casing base 20.

On the contrary, to open the casing cover 23 for taking small-sized stationery out of the accommodating space 22 for use, only push the pull member 236 inward to let the holding block 235 disengaged from the blocking surface 225 of the rear vertical surface 223 of the lower casing base 20 and then pull the pull member 236 outward to open the casing cover 23.

To sum up, this invention has the following advantages.

1. The lower casing base of the stapler of this invention is formed with an accommodating space in the interior for placing therein staplers, paper clips and other small-sized stationery under the condition of not enlarging the volume of the stapler, elevating usable value of products.

2. The casing cover can be firmly assembled on the accommodating space, able to prevent the articles placed in the accommodating space from dropping or losing. In addition, the casing cover can be opened easily by disengaging the holding block of the casing cover from the blocking surface of the lower casing base.

While the preferred embodiment of the invention has been described above, it will be recognized and understood that various modifications may be made therein and the appended claims are intended to cover all such modifications that may fall within the spirit and scope of the invention.

I claim:

1. A stapler comprising an upper casing base, a lower casing base and a staple box pivotally combined together, said staple box moved together with said upper casing base, said upper casing base and said staple box pressed downward on said lower casing base to release staples for carrying out stapling work: and characterized by,
Said upper and said lower casing base made of plastic, said lower casing base having its topside formed with an accommodating space, said accommodating space having its front vertical wall bored with an insert groove in the upper inner surface, said accommodating space having its rear vertical wall formed with a recess in the upper inner surface, said recess having its upper edge formed with a blocking surface, a casing cover covered on said accommodating space, said casing cover having its front end formed with an insert member extending outward, said insert member inserted in said insert groove of said front vertical wall of said accommodating space, said casing cover having its rear end formed with an elastic press retainer corresponding to said recess of said rear vertical wall of said accommodating space, said elastic press retainer having a basic portion extending downward from the topside of said casing cover, said basic portion of said elastic press retainer having its lower end bent upward to form an elastic press portion, said elastic press portion formed with a holding block at a location corresponding to said blocking surface of said rear vertical wall of said accommodating space, said casing cover able to be firmly assembled on said accommodating space by mutual engagement of said holding block of said elastic press retainer and said blocking surface.

2. The stapler as claimed in claim 1, wherein said elastic press retainer has its upper edge formed with a pull member extending outward for facilitating operation of said elastic press portion, and said lower casing base has its topside formed with an arc-shaped recessed surface corresponding to said pull member of said elastic press retainer for the convenience of pushing or pulling said pull member.

3. The stapler as claimed in claim 1, wherein said front and said rear vertical wall of said accommodating space are respectively provided with reinforcing ribs positioned at the opposite sides of said insert groove and said recess, said ribs having their upper edges propping up the lower side of said casing cover after said casing cover is covered on said accommodating space.

4. The stapler as claimed in claim 1, wherein said holding block of said elastic press retainer has its lower side formed with a guiding slope.

5. The stapler as claimed in claim 2, wherein said pull member of said elastic press retainer has its lower side formed with a guiding slope.
